(19) United States
(12) Patent Application Publication
(10) Pub. No.: US 2026/0169730 A1
(43) Pub. Date: Jun. 18, 2026

(54) Using AI/Decompiler to Verify Software Bill-of-Materials (SBOM)s

(71) Applicant: MICRO FOCUS LLC, WILMINGTON, DE (US)

(72) Inventors: MICHAEL F. ANGELO, HOUSTON, TX (US); DOUGLAS MAX GROVER, RIGBY, ID (US); ALEXANDER MICHAEL HOOLE, VANCOUVER (CA)

(73) Assignee: MICRO FOCUS LLC, WILMINGTON, DE (US)

(21) Appl. No.: 18/978,630

(22) Filed: Dec. 12, 2024

(51) Int. Cl. G06F 8/70; G06F 8/30; G06F 21/10

(52) U.S. Cl. CPC G06F 8/70; G06F 8/30; G06F 21/105

(57) ABSTRACT

A binary file is received. For example, a binary file of a software application is received by an AI algorithm. Based on the received binary file, binary source code is generated. The binary source code is compared to source code of a current Software Bill-of-Materials (current SBOM) that that is associated with the binary file to identify differences between the binary source code and the source code of the current SBOM. In response to determining that there are differences between the binary source code and the source code of the current SBOM, the identified differences between the binary source code and the source code of the current SBOM are stored in a memory. Component information associated with the identified differences between the binary source code and the source code of the current SBOM are displayed in a user interface. This allows a user to efficiently manage the differences.

### FIELD

The disclosure relates generally to software supply chain management and particularly to using Artificial Intelligence or a decompiler to compare source code generated from a binary file to source code of a current Software Bill-of-Materials.

### BACKGROUND

One of the problems with shipping products is trying to get the Software Bill-of-Materials (SBOM) correct. For various reasons, sometimes the SBOM of a product is not complete or is inaccurate. With the multitude of problems with software product supply chains and their associated component security, organizations, such as governments are requiring accurate SBOMs to identify components in software applications in order to reduce vulnerabilities that enable successful attacks.

### SUMMARY

These and other needs are addressed by the various embodiments and configurations of the present disclosure. The present disclosure can provide a number of advantages depending on the particular configuration. These and other advantages will be apparent from the disclosure contained herein.

A binary file is received. For example, a binary file of a software application is received by an AI algorithm. Based on the received binary file, binary source code is generated. The binary source code is compared to the source code used to generate a current Software Bill-of-Materials (current SBOM). By associating the binary file you can identify differences between the binary file and the source code for the current SBOM. In response to determining that there are differences between the binary source code and the source code of the current SBOM, the identified differences between the binary source code and the source code of the current SBOM are stored in a memory. Component information associated with the identified differences between the binary source code and the source code of the current SBOM are displayed in a user interface. This allows a user to efficiently manage the differences to create an accurate SBOM for the product.

The phrases "at least one", "one or more", “or,” and "and/or" are open-ended expressions that are both conjunctive and disjunctive in operation. For example, each of the expressions "at least one of A, B and C", "at least one of A, B, or C", "one or more of A, B, and C", "one or more of A, B, or C", "A, B, and/or C", and "A, B, or C" means A alone, B alone, C alone, A and B together, A and C together, B and C together, or A, B and C together.

The term "a" or "an" entity refers to one or more of that entity. As such, the terms "a" (or "an"), "one or more" and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As described herein, the term “component information” may include a software component name, a software component version, an origin of the software component, a hash of source code of the software component, the source code of the software component, developer(s) of the software component, date information, known vulnerabilities, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for using AI/decompiler to verify a current Software Bill-of-Materials (SBOM).

FIG. 2 is a block diagram of a second illustrative system for using AI to verify a current Software Bill-of-Materials (SBOM).

FIG. 3 is a block diagram of a third illustrative system for using AI to verify a current Software Bill-of-Materials (SBOM).

FIG. 4 is a block diagram of a fourth illustrative system for using a decompiler to verify a current Software Bill-of-Materials (SBOM).

FIG. 5 is a flow diagram of a process for using AI/decompiler to verify a current Software Bill-of-Materials(s).

FIG. 6 is a flow diagram of a process for managing missing/incorrect software components in a current Software Bill-of-Materials (SBOM).

FIG. 7 is a flow diagram of a process for managing extra software components in a current Software Bill-of-Materials (SBOM).

FIG. 8 is a diagram of a user interface that simplifies updating and managing a current SBOM and license file.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

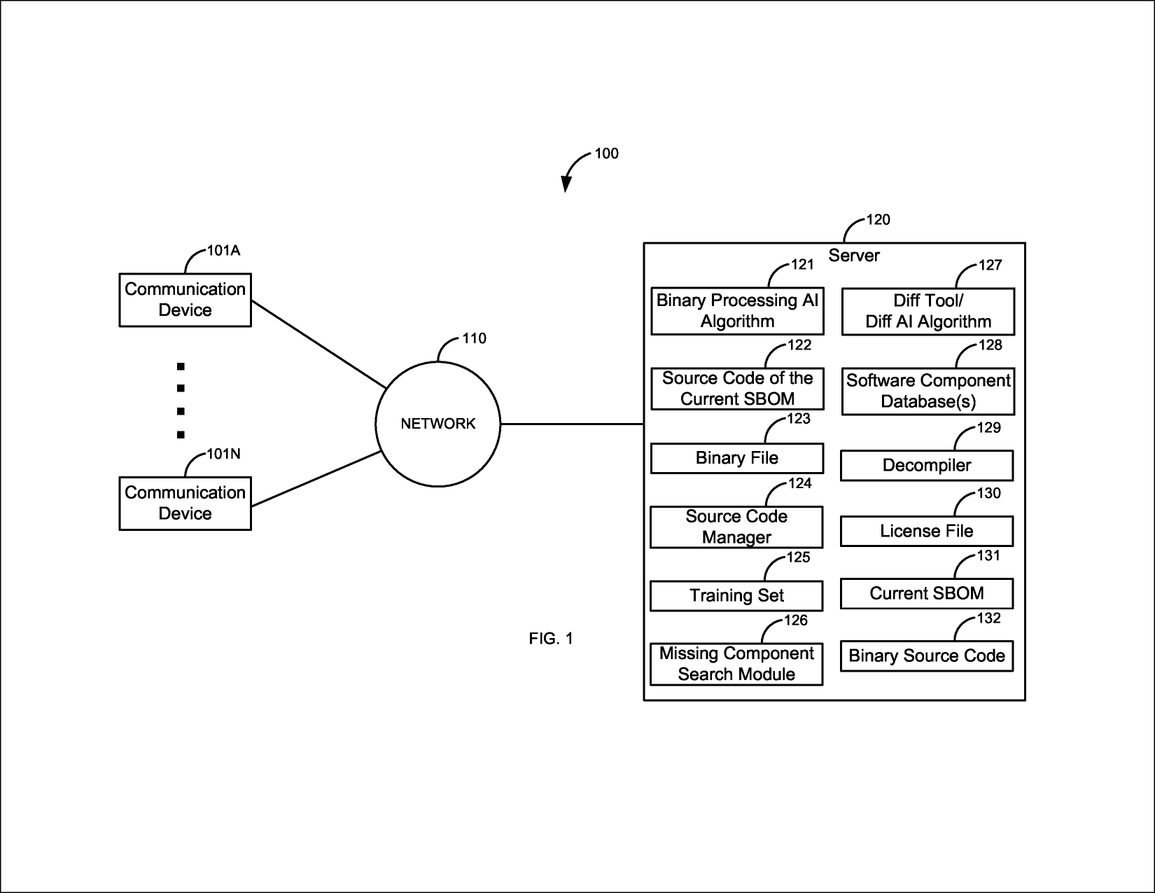

FIG. 1 is a block diagram of a first illustrative system 100 for using AI/decompiler 129 to verify a current Software Bill-of-Materials (SBOM) 122. The first illustrative system 100 comprises communication devices 101A-101N, a network 110, and a server 120.

The communication devices 101A-101N can be or may include any user device that can communicate on the network 110, such as a Personal Computer (PC), a cellular telephone, a Personal Digital Assistant (PDA), a tablet device, a notebook device, a laptop computer, a smartphone, and the like. As shown in FIG. 1, any number of communication devices 101A-101N may be connected to the network 110, including only a single communication device 101. Users use the communication devices 101A-101N to access the server 120.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The server 120 can be or may include any hardware coupled with software that is used to manage software supply chain information for a software application that is based on a binary file 123. The server 120 comprises a binary processing AI algorithm 121, source code of a current Software Bill-of-Materials (SBOM) 122, a binary file 123, a source code manager 124, a training set 125, a missing component search module 126, a diff tool/diff AI algorithm 127, a software component database(s) 128, a decompiler 129, a license file 130, a current SBOM 131, and binary source code 132.

The binary processing AI algorithm 121 is an AI algorithm that is designed to identify missing, extra, and/or incorrect version software components that are in the source code of the current SBOM 122 based on processing the binary file 123. In another embodiment, the binary processing AI algorithm 121 is used to generate the binary source code 132 by processing the binary file 123. The binary processing AI algorithm 121 may also comprise a vector AI algorithm that vectorizes the source code of the current SBOM 122, the binary source code 132, and/or source code of the training set 125.

The source code of the current SBOM 122 is grouping of source code files that are presumed to be all the source code files used to generate the binary file 123. The source code of the current SBOM 122 may include additional source code associated with the binary file 123, such as source code of libraries associated with the binary file 123.

The binary file 123 is an output of a compiler that takes source code to generate the binary file 123. The binary file 123 may include additional binary files 123, such as libraries that are called by the binary file 123 (e.g., a Dynamic Link Library (DLL)), other executable binaries that are called by the binary file 123, and/or the like.

The source code manager 124 can be or may include any hardware/software that is used to manage the current SBOM 131. The source code manager 124 uses the binary processing AI algorithm 121/decompiler 129/diff tool/diff AI algorithm 127 to produce an accurate current SBOM 131.

The training set 125 is used to train the binary processing AI algorithm 121. The training set 125 may comprise source code used to create binary files 123 and the corresponding binary files 123. The training set 125 may also include other information, such as the compiler, the compiler version, compiler options, and/or the like that were used to generate the binary file 123.

The missing component search module 126 is used to search the software component database(s) 128 to identify source code for any missing and/or correct software components in the current SBOM 122. The missing component search module 126 may search multiple software component databases 128 to identify the missing and/or correct software components. For example, the missing component search module 126 may search a local software component database 128 and an open-source software component database 128 on the network 110 to identify the missing and/or correct software components for the current SBOM 131. The missing component search module 126 may also be used to identify missing and/or incorrect software licenses.

The diff tool/diff AI algorithm 127 is used to determine differences between the source code of the current SBOM 122 and the binary source code 132. If the diff tool/diff AI algorithm 127 uses AI, the diff tool/diff AI algorithm 127 may be trained to identify differences/variances between source code of the current SBOM 122 and the binary source code 132. The diff AI algorithm 127 may be a vector AI algorithm that vectorizes the source code of the current SBOM 122 and the binary source code 132 to identify the missing, extra, and/or incorrect versions of software components.

The software component database(s) 128 may be repositories of source code that are stored locally on the server 120 and/or externally on the network 110. The software component database(s) 128 may include open-source source code, proprietary source code, third-party source code, and/or the like. In addition, the software component database(s) 128 may also include component information and/or associated software license information.

The decompiler 129 is used to decompile the binary file 123. The decompiler 129 is typically specific to the programming language of the source code of the current SBOM 122. The decompiler 129 takes the binary file 123 and produces the binary source code 132, which is then compared to the source code of the current SBOM 122 by the diff tool/diff AI algorithm 127 to determine if there are any differences. The decompiler 129 may also use the same compiler options that were used to create the binary file 123 as an input. The decompiler 129 may be a disassembler.

The license file 130 is used to track software licenses associated with an application (e.g., the binary file 123). The license file 130 may include open-source licenses, proprietary licenses, public domain licenses, and/or the like that are associated with the application.

The current SBOM 131 comprises component information about the different software components associated with the binary file 123. The current SBOM 131 is used to identify various kinds of component information associated with the binary file 123.

The binary source code 132 is source code that is generated based on the binary file 123. The binary source code 132 may be generated by the binary processing AI algorithm 121, the decompiler 129, and/or the like.

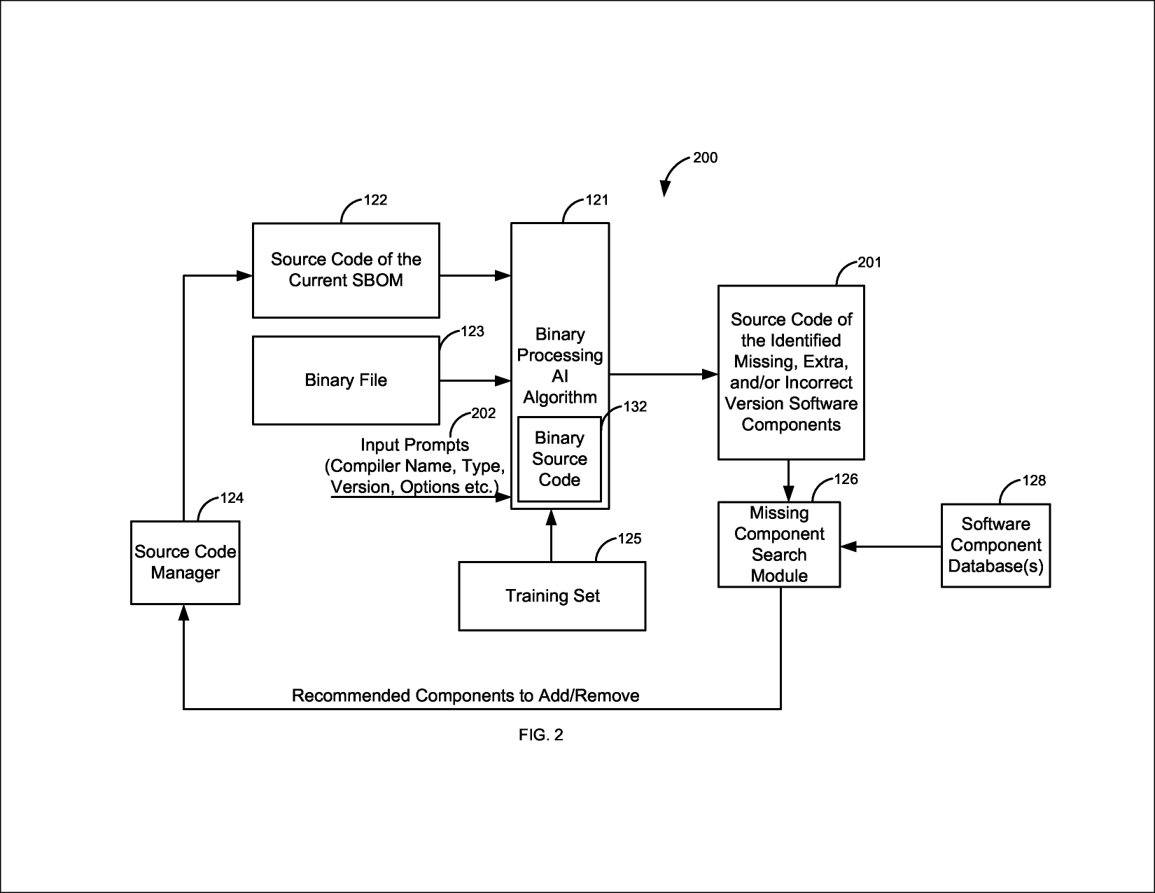

FIG. 2 is a block diagram of a second illustrative system 200 for using AI to verify a current Software Bill-of-Materials (SBOM) 131. The second illustrative system 200 comprises the binary processing AI algorithm 121, the source code of the current SBOM 122, the binary file 123, the source code manager 124, the training set 125, the missing component search module 126, the software component database(s) 128, the binary source code 132, the source code of the identified missing, extra, and/or incorrect version software components 201, and input prompts 202.

In FIG. 2, the source code of the identified missing, extra, and/or incorrect version software components 201 are an output from the binary processing AI algorithm 121. The source code of the identified missing, extra, and/or incorrect version software components 201 comprise the source code differences between the binary source code 132 and the source code of the current SBOM 122.

The input prompts 202 are input prompts 202 to the binary processing AI algorithm 121. The input prompts 202 may include the current source code of the current SBOM 122, the binary file 123, a compiler name, a compiler type, a compiler version, options used by the compiler to compile the binary file 123, and/or the like. In addition, the input prompts 202 may include text to direct the binary processing AI algorithm 121 to identify the source code of the missing, extra, and/or incorrect version software components 201 in the current SBOM 131 based on the binary file 123.

In FIG. 2, the binary processing AI algorithm 121 is trained on binaries, the corresponding source code used to generate the binaries, and/or compiler information (e.g., the compiler name, the compiler type, the compiler version, the compiler options, and/or the like). The binary source code 132 is internally generated by the binary processing AI algorithm 121 based on the binary file 123, and the input prompts 202. The binary source code 132 is created, by the binary processing AI algorithm 121 from the binary file 123 and compared to the source code of the current SBOM 122 to produce the source code of the identified missing, extra, and/or incorrect version software components 201. For example, the source code of the current SBOM 122 may be provided and then the source code of an associated library may be provided (e.g., in series) to the binary processing AI algorithm 121. Alternatively, the source code of the current SBOM 122 and the source code for library binaries along with the binary file 123/library binaries 123 may be provided in parallel. In addition, the input prompts 202 may identify the compiler type, compiler version, compiler options, etc. along with text to identify the source code of any identified missing, extra, and/or incorrect version software components 201 in the binary source code 132 in comparison to the source code of the current SBOM 122. This allows the user to have an idea of what software components to look for when updating the current SBOM 131.

In one embodiment, the binary processing AI algorithm 121 may comprise a vector AI algorithm that vectorizes the source code (e.g., into floating point vectors) in the current SBOM 122 and binary source code 132 to identify the source code of the missing, extra, and/or incorrect version software components 201. In addition, source code in the training set 125 may be vectorized to identify source code that is similar what is in the binary source code 132/source code of the current SBOM 122. For example, the binary processing algorithm 121 may vectorize source code for each software component in the training source code. This information can be clustered to identify binaries and source code that match. Outliers are identified as software components that do not match the binary source code 132, incorrect versions of software components in the binary source code 132, and/or missing software components that are not in the binary source code.

If there are missing software components and/or incorrect versions of software components, the missing software component search module 126 may identify which software component(s) are missing and/or incorrect. For example, the missing software component search module 126 may search a group of open-source repositories (software component databases 128) to identify source code that is similar to the source code of the missing, extra, and/or incorrect version software components 201. The missing component search module 126 may provide the recommended software components/component information to add/replace in the current SBOM 131 to the source code manager 124. The source code manager 124 can then update the current SBOM 131, based on the user input or automatically. For example, the user may take the recommendation(s) and add the missing component information, remove specific component information, replace specific component information, and/or the like to create a more accurate current SBOM 131.

If the newly identified software components that were missing and/or incorrect in the current SBOM 131 are added, software licensing information (e.g., an open-source license) can be identified and a check for proper attribution can be made to make sure that the existing license file 130 does not need updating. If there are new attribution/license requirements, this information may be added to a license file 130 to provide the necessary attribution/licensing information. This information may be displayed in a user interface and allow the user to approve the updates to the license information.

Likewise, if there are software components/component information in the current SBOM 131 that are not in the binary source code 132, the licensing information can be checked to see if any licensing information needs to be removed. This information may also be displayed to a user to allow the user to approve the removal of the necessary license information associated with the software components that are not in the binary source code 132.

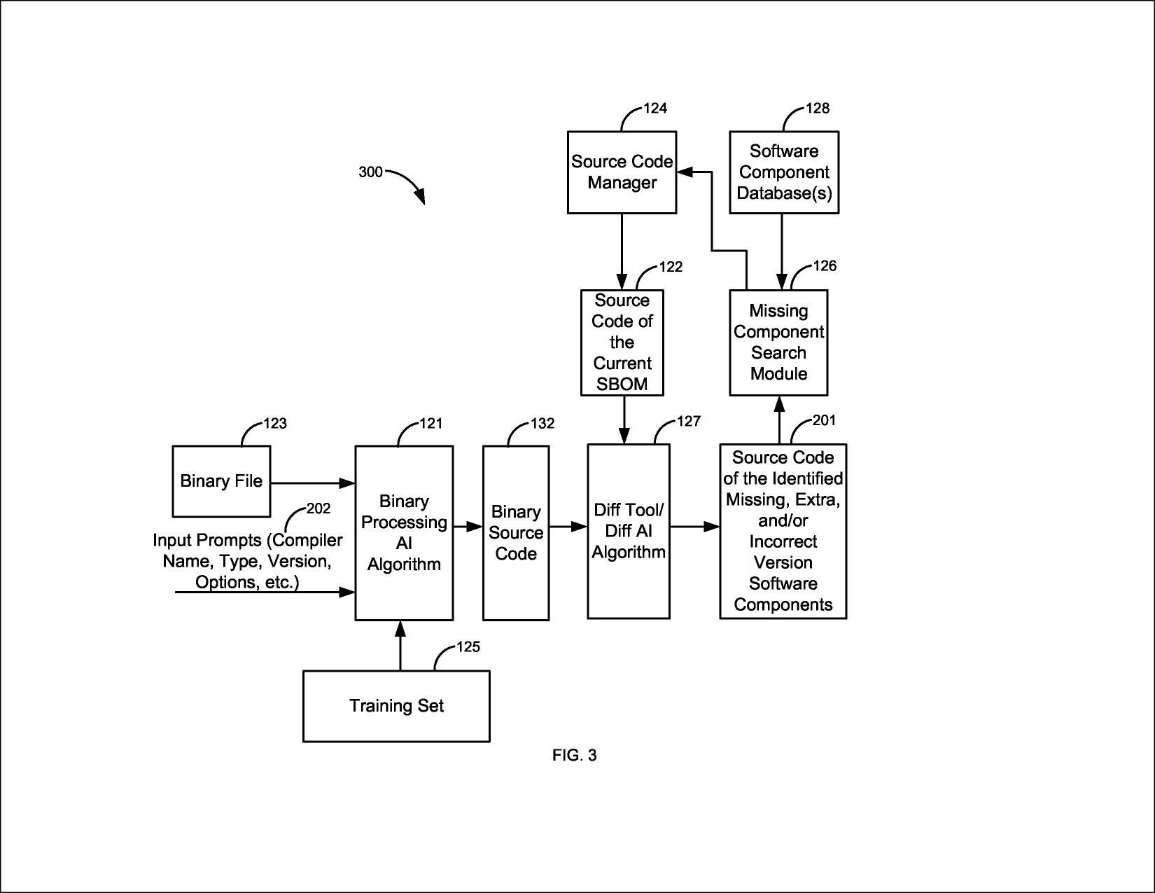

FIG. 3 is a block diagram of a third illustrative system 300 for using AI to verify a current Software Bill-of-Materials (SBOM) 122. The third illustrative system 300 comprises the binary processing AI algorithm 121, the source code of the current SBOM 122, the binary file 123, the source code manager 124, the training set 125, the missing component search module 126, the diff tool/diff AI algorithm 127, the software component database(s) 128, the binary source code 132, the source code of the identified missing, extra, and/or incorrect version software components 201, and the input prompts 202.

In FIG. 3, the binary file 123 is input into the binary processing AI algorithm 121. In addition, the input prompts 202 are an input to the binary processing AI algorithm 121. The input prompts 202 may include the compiler name, the compiler type, the compiler version, the compiler options, and/or the like. In addition, the input prompts 202 may include text to tell the binary processing AI algorithm 121 to generate the binary source code 132 based on the binary file 123 and/or the compiler name, type, version, and/or compiler options.

Based on the binary file 123 and optionally the input prompts 202, the binary processing AI algorithm 121 generates the binary source code 132. The binary source code 132 is source code used to create the binary file 123. The binary source code 132 is an input to the diff tool and/or diff AI algorithm 127. The diff tool/diff AI algorithm 127 compares the source code of the current SBOM 122 and the binary source code 132 to determine if there is source code for any missing, extra, and/or incorrect version software components 201. The diff AI algorithm 127 can be trained to identify functionality of source code. For example, the diff AI algorithm 127 can identify that the functionality is the same even though the structure of the source code is different when doing a comparison. The diff AI algorithm 127 may be a vector AI algorithm that vectorizes the source code of the current SBOM 122/binary source code 132 to determine any differences.

Like discussed in FIG. 2, the source code for missing software components, and/or incorrect software components 201 are an input to the missing software component search module 126 that can be used to identify any missing/incorrect version software components. This information along with component information about the extra software components can be provided to the source code manager 124 for a user to manage/update the current SBOM 131 in a more efficient manner. Likewise, the licensing information may be updated.

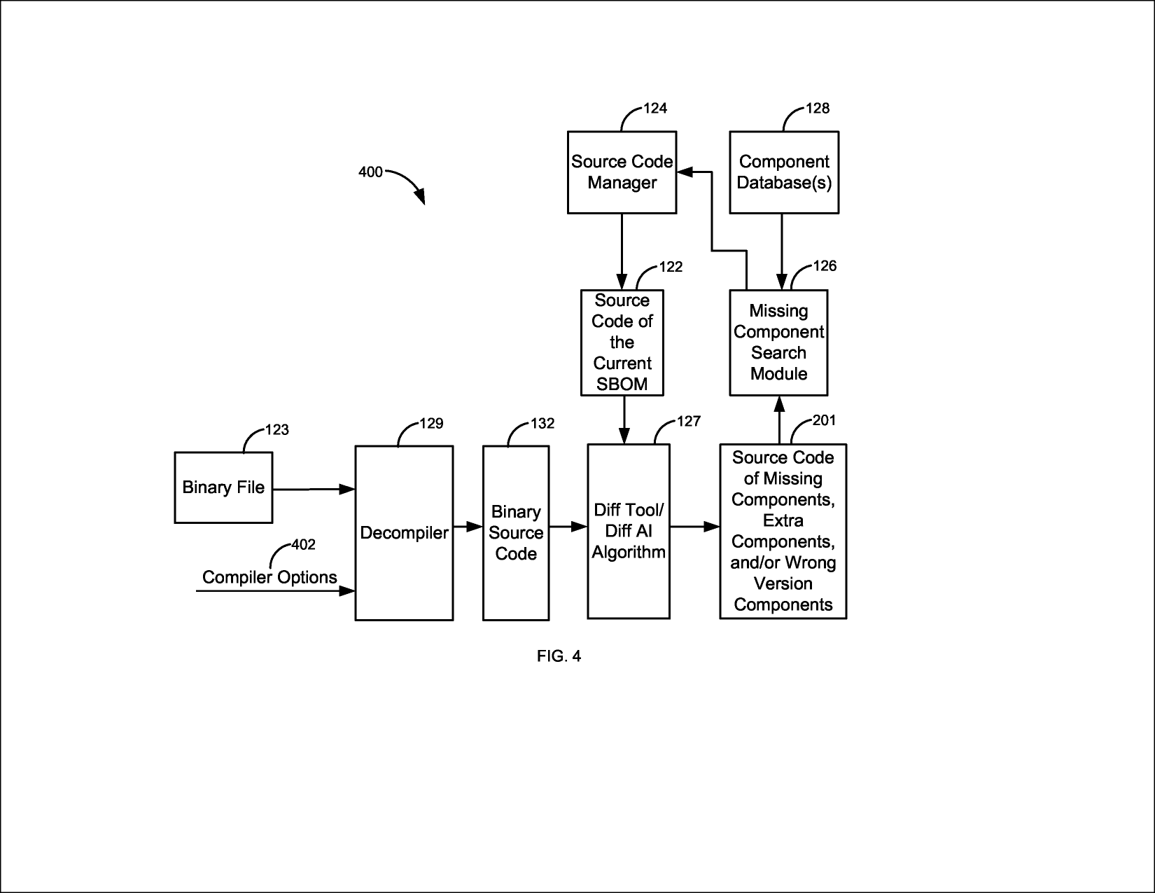

FIG. 4 is a block diagram of a fourth illustrative system 400 for using a decompiler 129 to verify a current Software Bill-of-Materials (SBOM) 122. The fourth illustrative system 400 comprises source code for the current SBOM 122, the binary file 123, the source code manager 124, the missing component search module 126, the diff tool/diff AI algorithm 127, the component database(s) 128, the decompiler 129, the binary source code 132, the source code for the identified missing, extra, and/or incorrect version software components 201, and compiler options 402.

The difference between FIG. 4 and FIG. 3 is that instead of using the binary processing AI algorithm 121, a decompiler 129 is used. The binary file 123 is an input to the decompiler 129. In addition, the same compiler options that were used to create the binary file 123 may be an input to the decompiler 129. Based on the input binary file 123 and/or the compiler options, the decompiler 129 generates the binary source code 132.

The diff tool/diff AI algorithm 127 then compares the source code of the current SBOM 122 to the binary source code 132 to determine the source code for the identified missing, extra, and/or incorrect version software components 201. If there is source code for the identified missing and/or incorrect version software components 201, the missing component search module 126 searches the component database(s) 128 to identify some or all of the of missing/incorrect version component information. The source code manager 124 then allows the user to select which component information to add to the current SBOM 131. In addition, software license information may be identified and added to the license file 130.

While FIGS. 2-4 are typically used in the development environment, these processes may be extended to the installation/execution process to further validate the binary file 123. For example, the binary file 123 may be tested with a specific version of a library that is in the current SBOM 131. On installation, the library version may be different, thus resulting in the current SBOM 131 for the installed version being different. Also, some installers install from locations on the Internet. If a different version of a file is installed from the Internet, checking the current SBOM 131 can catch issues.

Before the binary file 123 is installed, the customer may go out and get the source code for the current SBOM 122 and then run the test to validate that the binary source code 132 matches the source code of the current SBOM 122. If they match, then the binary file 123 is installed. If there are missing, extra, and/or incorrect version software components these can be flagged to the user.

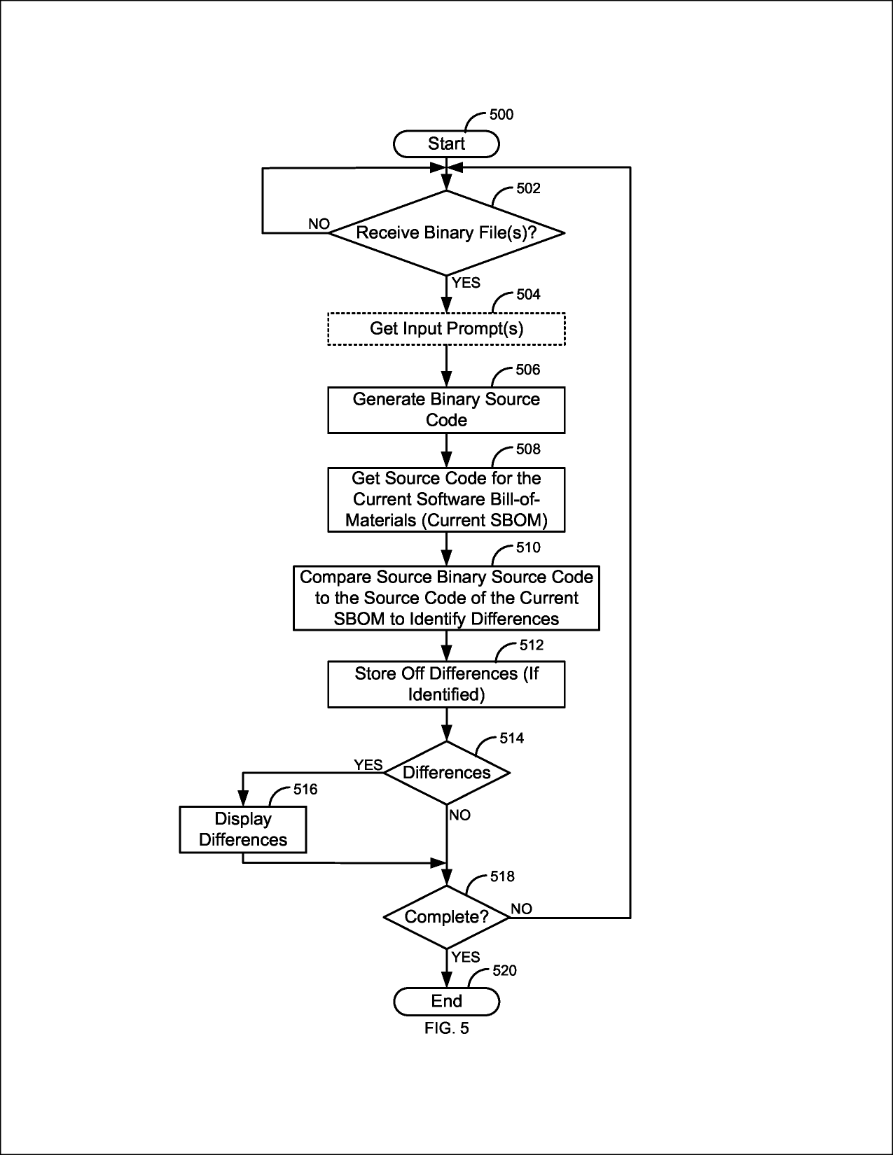

FIG. 5 is a flow diagram of a process for using the binary processing AI algorithm 121 or the decompiler 129 to verify a current Software Bill-of-Materials(s) 131. Illustratively, the communication devices 101A-101N, the server 120, the binary processing AI algorithm 121, the binary file 123, the source code manager 124, the missing component search module 126, the diff tool/diff AI algorithm 127, and the decompiler 129, are stored-program-controlled entities, such as a computer or microprocessor, which performs the method of FIGS. 5-8 and the processes described herein by executing program instructions stored in a computer readable storage medium, such as a memory (i.e., a computer memory, a hard disk, and/or the like). Although the methods described in FIGS. 5-8 are shown in a specific order, one of skill in the art would recognize that the steps in FIGS. 5-8 may be implemented in different orders and/or be implemented in a multi-threaded environment. Moreover, various steps may be omitted or added based on implementation.

The process starts in step 500. The binary processing AI algorithm 121 or decompiler 129 wait in step 502 to receive the binary file(s) 123 (e.g., the binary file 123 and binary files 123 from libraries). If the binary file(s) 123 are not received in step 502, the process of step 502 repeats.

Otherwise, if the binary file(s) 123 are received, in step 502, if the binary processing AI algorithm 121 is used, the binary processing AI algorithm 121 gets the input prompts 202 in step 504. For example, the input prompts 202 may include the source code for the current SBOM 122, a compiler name, a compiler type, a compiler version, options used by the compiler to compile the binary file 123, text to direct the binary processing AI algorithm 121 to identify the source code for the missing, extra, and/or incorrect version software components 201 in the current SBOM 131, text to tell the binary processing AI algorithm 121 to generate the binary SBOM 203 based on the binary file 123, and/or the like.

The binary processing AI algorithm 121 or decompiler 129 generates, in step 506, the binary source code 132. For example, the binary processing AI algorithm 121 may internally generate the binary source code 132 as described in FIG. 2 or may externally generate the binary source code as described in FIG. 3. The binary source code 132 is in the same programming language as the source code for the current SBOM 122 (e.g., in C++, Java, etc.). If it is the decompiler 129, the decompiler 129 directly generates the binary source code in step 506 like described in FIG. 4.

The binary processing AI algorithm 121 (e.g., as described in FIG. 2) or the diff tool/diff AI algorithm 127 (e.g., as described in FIGS. 3-4) gets the source code for the current SBOM 122 in step 508. The binary processing AI algorithm 121 or the diff tool/diff AI algorithm 127 compares the binary source code 132 to the source code of the current SBOM 122 in step 510. The differences are than stored off in step 512 (if any are identified). For example, the differences (e.g., missing software components) may be stored off in a memory.

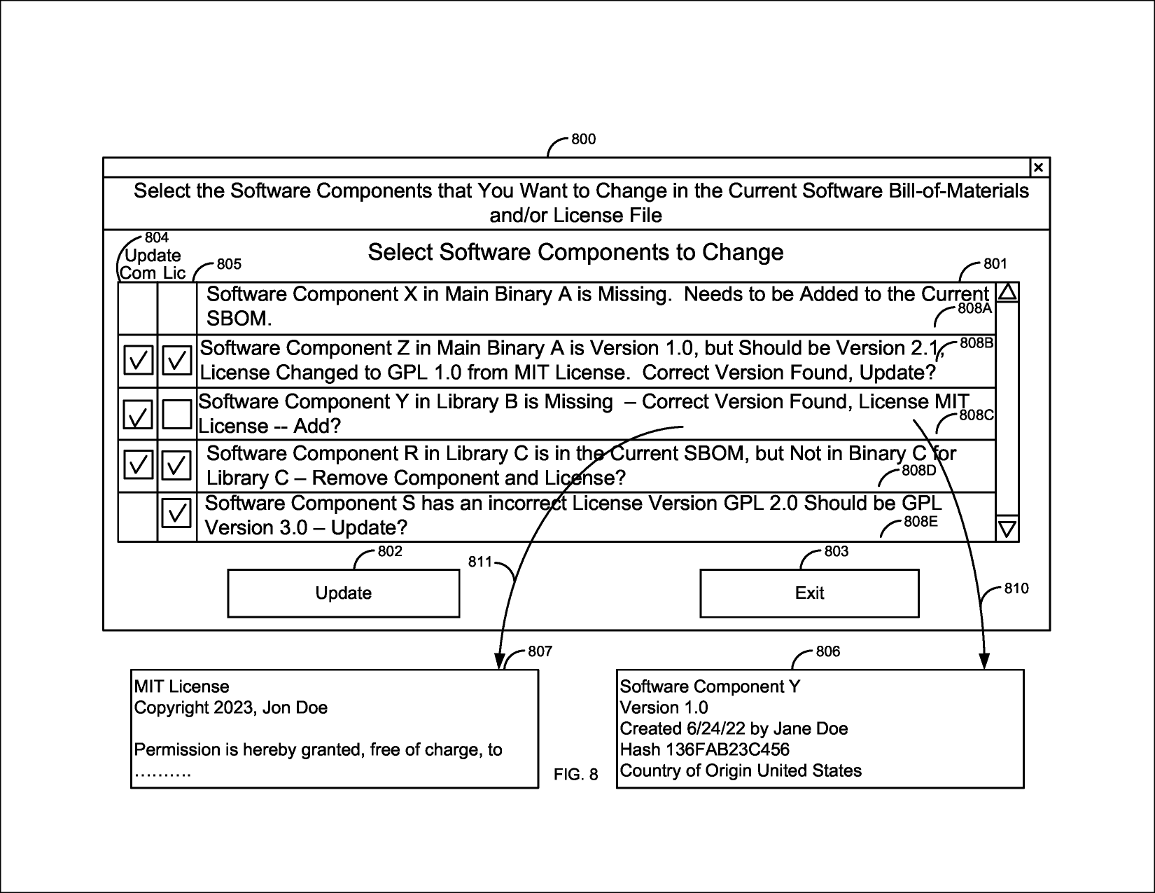

If there are no differences in step 514, the process goes to step 518. If there are differences in step 514, the differences are generated for display and then displayed to a user in a user interface and the process goes to step 518. For example, the differences may be displayed to the user as shown in FIG. 8. This allows the user to easily manage and update any differences.

The source code manager 124 determines, in step 518, if the process is complete. If the process is not complete in step 518, the process goes back to step 502. Otherwise, if the process is complete in step 518, the process ends in step 520.

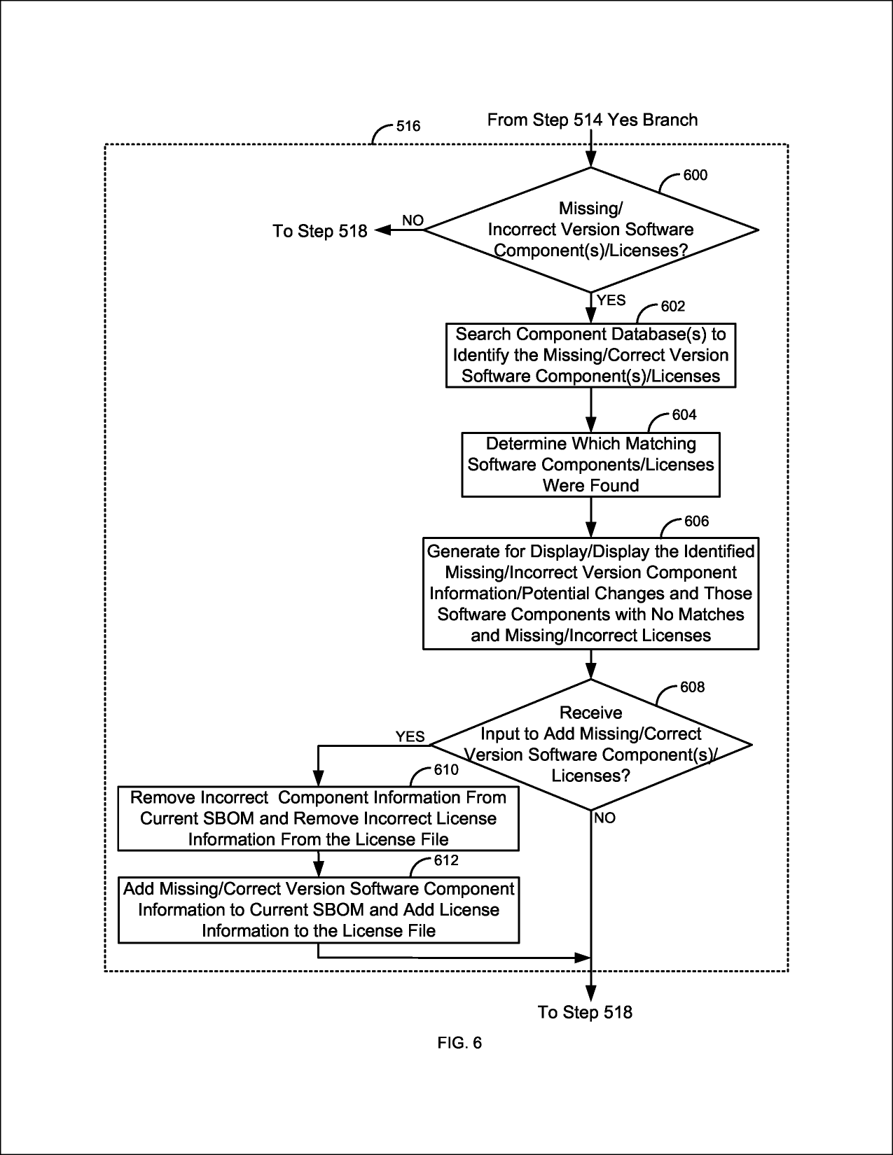

FIG. 6 is a flow diagram of a process for managing missing/incorrect software components in a current Software Bill-of-Materials (SBOM) 122. FIG. 6 is an exemplary embodiment of step 516 of FIG. 5.

After determining that there are differences in step 514, the source code manager 124 determines, in step 600, if there are any missing or incorrect versions of software component(s) and/or software licenses. If there are not any missing or incorrect versions of software component(s) and/or licenses in step 600, the process goes to step 518.

Otherwise, if there are missing or incorrect versions of software component(s) and/or software licenses in step 600, the missing component search module 126 searches the component database(s) 128 to identify the missing software components and/or the correct versions of the software components (for identified incorrect versions) in step 602. For example, the missing component search module 126 can compare the source code for the missing, extra, and/or incorrect version software components 201 to source code in the software component database(s) 128 to find a match. In addition, the missing component search module 126 may identify any missing/incorrect versions of software licenses in step 602. The missing component search module 126 determines, in step 604, which matching software components that were not in the current SBOM 131/incorrect versions and/or missing/incorrect software licenses were found in the component database(s) 128.

The source code manager 124 generates for display the identified missing or incorrect versions of software component(s) 201 and component information for those software components with no matches in step 606. The identified missing or incorrect component information of the versions of software component(s) 201/potential changes and those software components with no matches are then displayed along with any missing/incorrect software licenses in step 606 (e.g., by a web browser). The source code manager 124 waits, in step 608, to receive user input to add missing and/or correct the component information for the version’s software components (for those that were not correct/missing) and/or correct software licenses. If no user input is received in step 608, the process goes to step 518.

Otherwise, if there is user input to add missing and/or correct component information for the versions of software components to the current SBOM 131 and/or missing and/or correct versions of the licenses to the license file 130 in step 608, the source code manager 124 removes any selected incorrect component information for the versions of software component(s) from the current SBOM 131 and removes any incorrect license information (if selected to do so) from the license file 130 in step 610. The source code manager 124 then adds any missing and/or correct component information for the versions of software component(s) to the current SBOM 131 and adds the license information to the license file 130 (if selected to do so) in step 612. The process then goes to step 518.

To illustrate, consider the following example. If the software version of software component A is version 1.0 in the current SBOM 131 and the identified software component A is version is 2.0 based on the binary source code 132 being compared to what is in the component database 128, the system will display an indication that the version 1.0 is incorrect and needs to be replaced with version 2.0 of the software component A. This may include replacing and then adding new software license information if the software license information has changed.

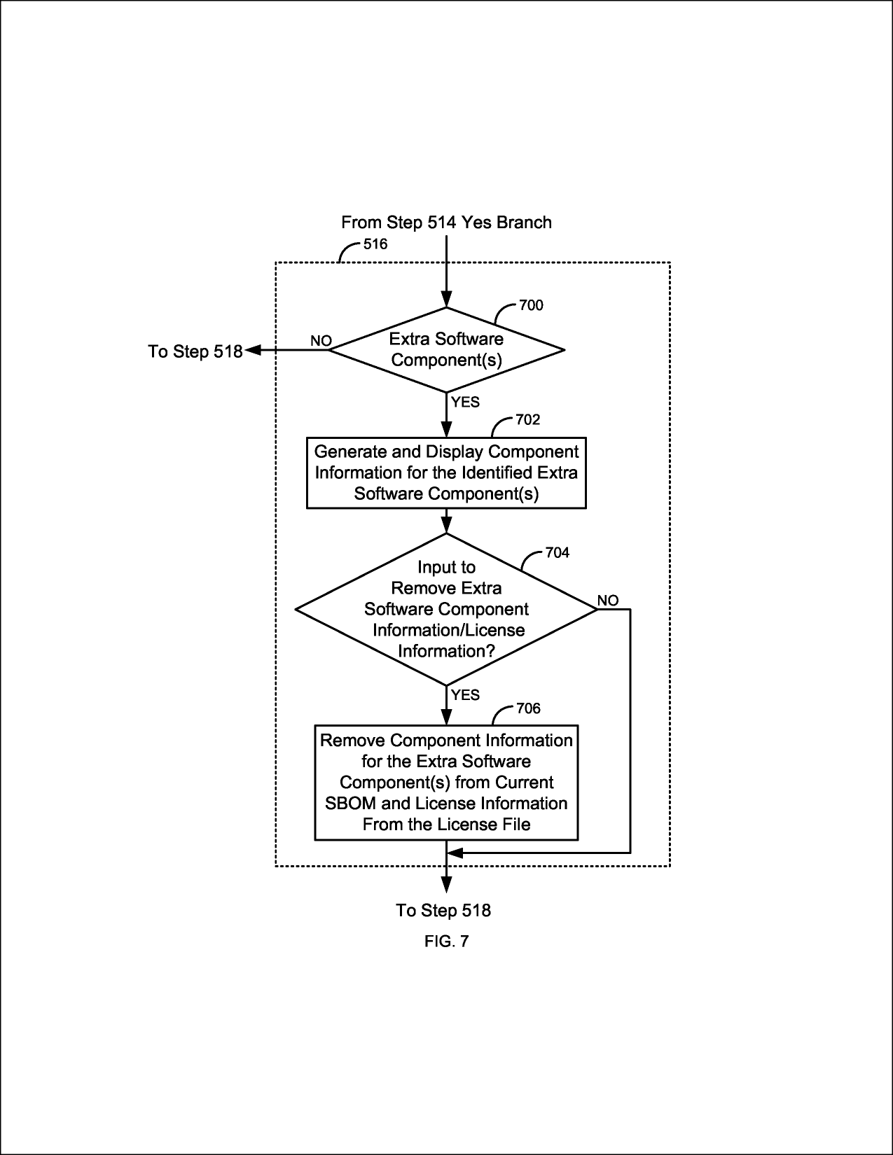

FIG. 7 is a flow diagram of a process for managing extra software components in a current Software Bill-of-Materials (SBOM) 131. The process of FIG. 7 is an exemplary embodiment of step 516 of FIG. 5. The process of FIG. 7 may run in parallel with the process of FIG. 6.

After determining that there are differences in step 514, the source code manager 124 determines, in step 700, if there are any extra software component(s) in the current SBOM 131. If there are not any extra software components in the current SBOM 131, the process goes to step 518.

Otherwise, if there are extra software component(s) in the current SBOM 131, the source code manager 124 generates for display the identified extra software component(s) in step 702. The extra software component(s) are then displayed to the user (e.g., by a browser) in step 702. The source code manager 124 waits, in step 704 to receive input from the user to remove the component information for the extra software components from the current SBOM 131. If there is no user input in step 704, the process goes to step 518. Otherwise, if there is user input in step 704, the source code manager 124 removes the component information for the extra software component(s) from the current SBOM 131 and the associated software licenses from the license file 130 (if selected) in step 706. The process then goes to step 518.

FIG. 8 is a diagram of a user interface that simplifies updating and managing a current SBOM 131 and license file 130. The user interface comprises a management window 800, a component information window 806, and a license management window 807.

The management window 800 allows a user to manage specific component information for software components that are either missing from the current SBOM 131, the wrong version in the current SBOM 131, or need to be removed from the current SBOM 131. In addition, the management window 800 also allows the user to add/update/remove license information from the license file 130.

The management window 800 comprises a components list 801, an update button 802, and an exit button 803. The components list 801 lists the different software components in the current SBOM 131/license file 130 that have issues 808A-808E. The components list 801 also comprises a component update column 804, and an update license column 805.

The issues 808A-808E may be that the component information is missing, that the component information is wrong version, that the component information needs to be removed, that the license information needs to be removed from the license file 130, that the license information needs to be added to the license file 130, that the license information needs to be changed in the license file 130, and/or the like. The components list 801 comprises five different software components that have issues 808A-808E: 1) software component X is missing from the main binary (808A), 2) the software component Z in the main binary is version 1.0, but should be version 2.1 and the license changed to the GPL 1.0 license from the MIT license (808B), 3) that the software component Y in library B is missing and uses the MIT license (808C), 4) that the software component R in library C is in the current SBOM 131, but not in the binary C for the library C (808D), and 5, that the software component S has an incorrect version GPL 2.0, but should be GPL 3.0 (808E).

The issue 808A does not have any check boxes in the component update column 804 and the update license column 805 because the missing components search module 126 could not find the correct component information/license information. The issue 808B has check boxes in the component update column 804 and the update license column 805 because both the correct version of the software component Z and the correct version of the software license were found. The user has selected both check boxes for the issue 808B to update the current SBOM 131 and the license file 130. The issue 808C has check boxes in the component update column 804 and the update license column 805 because correct component information and the license (MIT) have been found by the missing component search module 126. The user has selected to update the component Y in the current SBOM 131 but not to update the license file 130 with the MIT license. The issue 808D has check boxes in the component update column 804 and the update license column 805 to update the current SBOM 131 and the license file 130 because component R is not in the binary C for library C. In this example, the user wants to remove both the component information for the component R from the current SBOM 131 and the corresponding license from the license file 130. The issue 808E has only a checkbox in the update license column 805 because the current version in the license file 130 is incorrect and needs to be updated to GPL version 3.0. For the issue 808E, the user has selected to update the license file 130 to the correct version (GPL version 3.0).

The user can also view the component information for the newly identified software component and/or newly identified license. For example, the user can right click on the issue 808C, in step 810, to show the component information for the software component Y in the component information window 806. In a similar manner, the user can left click on the issue 803C, in step 811, to show the MIT license for the identified software component Y. Although not shown, the user may click on the issue 808A to view the source code for the missing software component X in a window.

Once the user has selected the changes via the check box(es), the user can click on the update button 802 to automatically make the changes to the current SBOM 131/license file 130. The user can click on the exit button 803 to close the management window 800.

While the above process is described using check boxes and different types of clicks, one can envision that the above processes may be accomplished using different methods/interfaces/graphical objects. For example, buttons may be used instead of check boxes or to view source code/license information. Alternatively, the clicking may be the opposite (e.g., right click to view the license and left click to view the component information).

Once of the key advantages to the management window 800 is that it dramatically improves/simplifies the current management process of how the current SBOM 131/license file 130 are managed. Currently, the user has to separately review/manage the current SBOM 131/license file 130 for a product and separately review the license file 130. This manual process leads to inaccurate current SBOMs 131/inaccurate license files 130. The management window 800 simplifies the process and is much more accurate than the current processes. This is because the user can easily identify the issues 808A-808E and easily update the current SBOM 131/license file 130 to produce a more accurate current SBOM 131/license file 130.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive a binary file;
based on the received binary file, generate binary source code;
compare the binary source code to source code of a current Software Bill-of-Materials (SBOM) that that is associated with the binary file to identify differences between the binary source code and the source code of the current SBOM;
in response to determining that there are differences between the binary source code and the source code of the current SBOM, store, in a memory, the identified differences between the binary source code and the source code of the current SBOM; and
generate, for display in a user interface, component information associated with the identified differences between the binary source code and the source code of the current SBOM.

2. The system of claim 1, wherein the identified differences between the binary source code and the source code of the current SBOM comprise one or more missing software components and/or one or more missing software licenses and wherein the microprocessor readable and executable instructions further cause the microprocessor to:
search a component database to identify the one or more missing software components and/or the one or more missing software licenses; and
generate for display, in a user interface, the identified one or more missing software components and/or the identified one or more missing software licenses;
receive, via the user interface, an input to add component information for the identified one or more missing software components to the current SBOM and/or the identified one or more missing software licenses to a license file; and
add the component information for the one or more identified missing software components to the current SBOM and/or the identified one or more missing software licenses to the license file.

3. The system of claim 1, wherein the identified differences between the binary source code and the source code of the current SBOM comprise one or more incorrect software components and/or one or more incorrect software licenses and wherein the microprocessor readable and executable instructions further cause the microprocessor to:
search a component database to identify one or more correct software components and/or one or more correct software licenses; and
generate for display, in a user interface, component information for the identified one or more correct software components and/or the identified one or more correct software licenses;
receive, via the user interface, an input to replace component information for the identified one or more incorrect software components in the current SBOM and/or the identified one or more incorrect software licenses from a license file;
remove the component information for the identified one or more incorrect software components from the current SBOM and/or remove the identified one or more incorrect software licenses from the license file; and
add the component information for the identified one or more correct software components to the current SBOM and/or add the identified one or more correct software licenses to the license file.

4. The system of claim 1, wherein the wherein the identified differences between the binary source code the source code of the current SBOM comprise one or more extra software components in the binary source code.

5. The system of claim 1, wherein the binary file and the source code of the current SBOM are input prompts to a binary processing AI algorithm and wherein the binary processing AI algorithm is trained on source code used to generate corresponding binaries and the corresponding binaries.

6. The system of claim 5, wherein the input prompts also comprise an input prompt that identifies one or more of: a compiler type, a compiler version, a compiler name, a compiler option, and text to direct the binary processing AI algorithm to identify source code of missing, extra, and/or incorrect version software components in the current SBOM.

7. The system of claim 5, wherein the binary processing AI algorithm further comprises a vector AI algorithm that vectorizes the source code of the current SBOM and binary source code to identify the differences between the binary source code and the source code of the current SBOM.

8. The system of claim 1, wherein the binary file is an input prompt to a binary processing AI algorithm, wherein the binary processing AI algorithm is trained on source code used to generate corresponding binaries and the generated corresponding binaries, wherein an output from the binary processing AI algorithm is the binary source code, and wherein comparing the binary source code to the source code of the current SBOM is accomplished by at least one of: a diff tool or a diff AI algorithm.

9. The system of claim 8, wherein in the comparing of the binary source code to the source code of the current SBOM is accomplished by the diff AI algorithm and wherein the diff AI algorithm is a vector AI algorithm that vectorizes the binary source code and the source code of the current SBOM.

10. The system of claim 1, wherein the binary file is an input to a decompiler, wherein the binary source code is an output of the decompiler, and wherein comparing the binary source code to the source code of the current SBOM is accomplished by at least one of: a diff tool or a diff AI algorithm.

11. The system of claim 1, wherein comparing the binary source code to the source code of the current SBOM that that is associated with the binary file to identify any differences between the binary source code and the source code of the current SBOM is accomplished when the binary file is being installed and/or being executed.

12. A method comprising:
receiving, by a microprocessor, a binary file;
based on the received binary file, generating, by the microprocessor, binary source code;
comparing, by the microprocessor, the binary source code to source code of a current Software Bill-of-Materials (SBOM) that that is associated with the binary file to identify differences between the binary source code and the source code of the current SBOM;
in response to determining that there are differences between the binary source code and the source code of the current SBOM, storing, by the microprocessor, in a memory, the identified differences between the binary source code and the source code of the current SBOM; and
generating, for display in a user interface, component information associated with the identified differences between the binary source code and the source code of the current SBOM.

13. The method of claim 12, wherein the binary file and the source code of the current SBOM are input prompts to a binary processing AI algorithm and wherein the binary processing AI algorithm is trained on source code used to generate corresponding binaries and the corresponding binaries.

14. The method of claim 13, wherein the input prompts also comprise an input prompt that identifies one or more of: a compiler type, a compiler version, a compiler name, a compiler option, and text to direct the binary processing AI algorithm to identify source code of missing, extra, and/or incorrect version software components in the current SBOM.

15. The method of claim 13, wherein the binary processing AI algorithm further comprises a vector AI algorithm that vectorizes the source code of the current SBOM and binary source code to identify the differences between the binary source code and the source code of the current SBOM.

16. The method of claim 12, wherein the binary file is an input prompt to a binary processing AI algorithm, wherein the binary processing AI algorithm is trained on source code used to generate corresponding binaries and the generated corresponding binaries, wherein an output from the binary processing AI algorithm is the binary source code, and wherein comparing the binary source code to the source code of the current SBOM is accomplished by at least one of: a diff tool or a diff AI algorithm.

17. The method of claim 16, wherein in the comparing of the binary source code to the source code of the current SBOM is accomplished by the diff AI algorithm and wherein the diff AI algorithm is a vector AI algorithm that vectorizes the binary source code and the source code of the current SBOM.

18. The method of claim 12, wherein the binary file is an input to a decompiler, wherein the binary source code is an output of the decompiler, and wherein comparing the binary source code to the source code of the current SBOM is accomplished by at least one of: a diff tool or a diff AI algorithm.

19. The method of claim 12, wherein comparing the binary source code to the source code of the current SBOM to identify any differences between the binary source code and the source code of the current SBOM is accomplished when the binary file is being installed and/or being executed.

20. A non-transient computer readable medium having stored thereon instructions that cause a processor to execute a method, the method comprising instructions to:
receive a binary file;
based on the received binary file, generate binary source code;
compare the binary source code to source code of a current Software Bill-of-Materials (SBOM) that that is associated with the binary file to identify differences between the binary source code and the source code of the current SBOM;
in response to determining that there are differences between the binary source code and the source code of the current SBOM, store, in a memory, the identified differences between the binary source code and the source code of the current SBOM; and
generate, for display in a user interface, component information associated with the identified differences between the binary source code and the source code of the current SBOM.
